(19) United States
(12) Patent Application Publication
(10) Pub. No.: US 2003/0110589 A1
(43) Pub. Date: Jun. 19, 2003

(54) Door closer

(76) Inventor: Kun Long Lin, Taichung (TW)

Correspondence Address: Liberty Patent & Trademark Office, P.O. BOX 590, Taichung City, Taichung, 406, TW

(21) Appl. No.: 10/021,644

(22) Filed: Dec. 19, 2001

(51) Int. Cl. E05F 3/00

(52) U.S. Cl. 16/66

(57) ABSTRACT

A door closer, having a mobile rod that is axially installed on a main unit, on the mobile rod being a cantable washer and an elastic member, characterized in that: an elastic member is installed between the cantable washer and the main unit, the elastic member being installed on the mobile rod; thereby the door can be closed convenient by applying a minimum force to push the door further, then the mobile rod will be extended, and the elastic member will automatically push and unlatch the arrest of the cantable washer, so that the cantable washer is released from the mobile rod, and then the mobile rod can be retracted smoothly into the main unit.

### BACKGROUND OF THE INVENTION

(a) Field of the Invention

The invention relates to a door closer that is installed on a door or doorframe, and more particularly to a door closer with auto unlatching to release a arrested door.

(b) Description of the Prior Art

A door closer is an apparatus that is installed between a door and a wall. When a door is opened, a cantable washer is used on the door closer to cants and arrests the door in an open position. To close the door, one must unlatch the arrest of the door on door closer, and the door will be closed automatically.

Please refer to FIG. 1, the general door closer comprises a main unit 11, a mobile rod 12 and a cantable washer 13. The mobile rod is axially installed in the main unit 11 for extension and retraction. Under a normal condition, the mobile rod 12 is retracted inside the main unit 11. The cantable washer 13 is a washer in bent form with a through hole 14. The mobile rod 12 is passing through the through hole 14. In general application, one end of the main unit 11 is attached to a doorframe or wall, the mobile rod 12 is extending from the free end of the main unit 11, the extending end of mobile rod 12 is attached to a door.

In daily operation, such as moving out goods or furniture from house, a door must be kept open for a period of time. As shown in FIG. 2, the mobile rod 12 of the door closer is extended out from the main unit 11. When the door is opened to a position, the cantable washer 13 is moved manually to against the main unit 11. Then, the adjusts the cantable washer 13 inclined, so the wall of through hole 14 is brought to contact with the mobile rod 12, since the mobile rod 12 has a resiliency to retract back in the main unit 11, it canted by this contact. In other words when the door is opened to a position, use the cantable washer 13 can arrest the door and keep it open. To unlatch the arrest of door, the user need to push the door further a small distance to release the cantable washer 13 from mobile rod 12 then moves the cantable washer 13 away from the main unit. Therefore, unlatch the arrest on the mobile rod 12, and the mobile rod 12 retracts back to the main unit 11.

Though, the prior art of door closer is capable to arrest a door, but in the unlatching operation, the user has to manually release the cantable washer 13 from mobile rod 12 as well the main unit 11. When a door that is opened to a maximum limit, it is difficult for the user to push the door further to release the cantable washer 13 to close the door.

Further, if the door closer is installed at a higher position of the door or door frame, it would be a problem to child, handicapped person and old people who is difficult to reach the cantable washer 13 neither to move it for unlatching the arrest of the door.

### SUMMARY OF THE INVENTION

The primary objective of the present invention is to provide a door closer which can auto release the cantable washer 13 of door closer for unlatching the arrested door conveniently. A preferred embodiment of the present invention refers to a door closer, comprising a mobile rod that is axially installed on a main unit, a cantable washer and an elastic member are fitted onto the mobile rod, particularly the elastic member being between the main unit and cantable washer, two ends of the elastic member being contact with the main unit and the cantable washer respectively. When the door is arrested by cants the mobile rod with cantable washer, the elastic member be compressed between main unit and cantable washer.

Thereby, to unlatch the arrested door by pushing door further, the cantable washer is loosed from the main unit and the mobile rod, then the elastic member pushes the cantable washer away from main unit, and the mobile rod can be retracted back to the main unit smoothly to close the door.

### BRIEF DESCRIPTION OF DRAWINGS

FIG. 1 is a schematic view of a prior art of door closer.

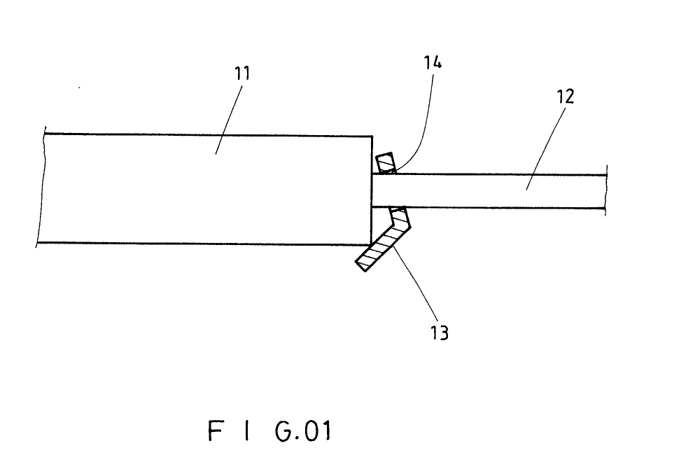

FIG. 2 is a schematic view of a prior art of door closer in operation.

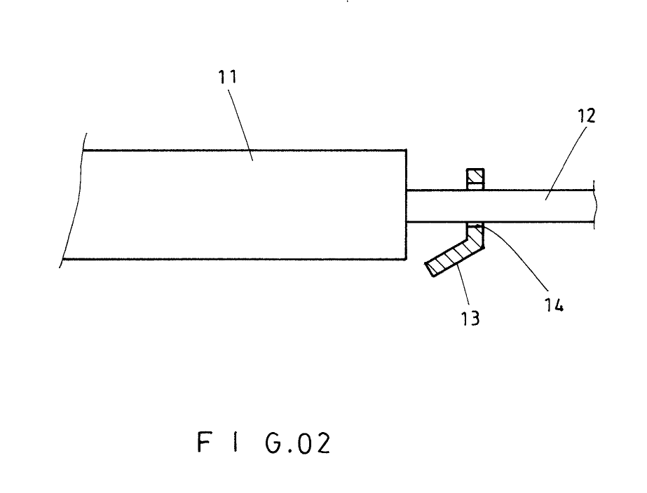

FIG. 3 is an exploded view of present invention.

FIG. 4 is a schematic view of present invention.

FIG. 5 is a schematic view of present invention when the door is arrested.

FIG. 6 is a schematic view of present invention when the door is unlatched.

### DETAILED DESCRIPTION OF PREFERRED EMBODIMENTS

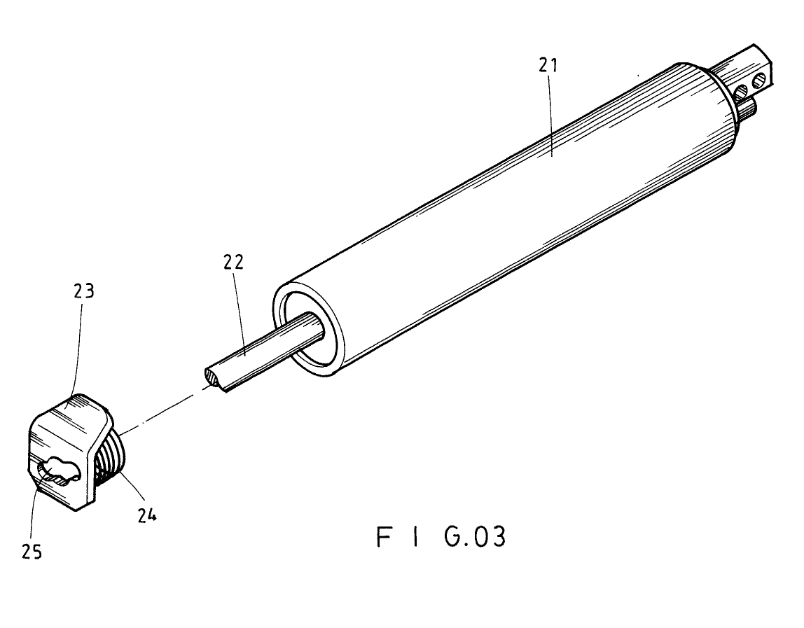

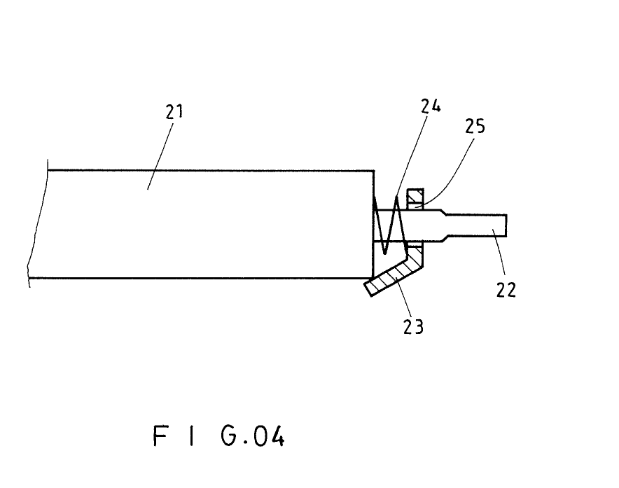

As shown in FIGS. 3 and 4, the present invention comprises a main unit 21, a mobile rod 22, a cantable washer 23 and an elastic member 24. The mobile rod 22 is installed in the main unit 21. The cantable washer 23 is a bent washer having a through hole 25 on it. One end of the mobile rod 22 is extended from the main unit 21 and passed through the elastic member 24 and the through hole 25 of the cantable washer 23, the elastic member is a spring in this application. One end of the elastic member 24 contacts the end where the mobile rod 22 extending out of main unit 21 and the other end contacts against the surface of the cantable washer 23.

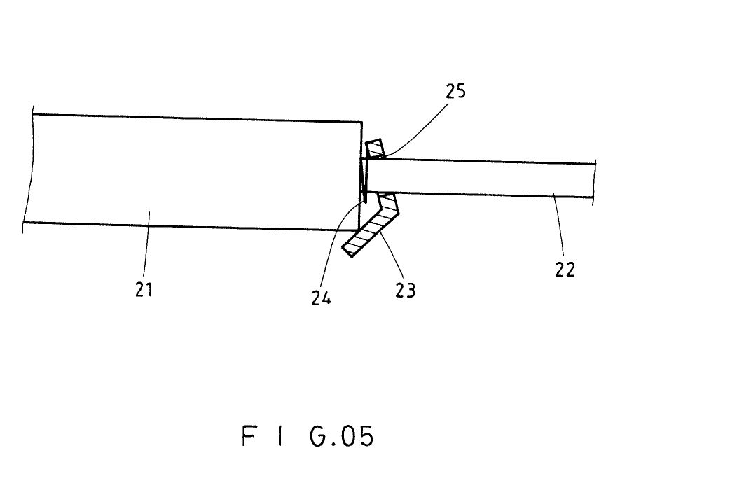

When in application, the door closer is installed between a door (not shown in the drawing) and a doorframe or wall, the extending end of mobile rod 22 is mounted on the door. Please refer to FIG. 5; to open the door, the door is pushed and the mobile rod 22 is extended away from the main unit 21 until to a wanted position, the user then move the cantable washer 23 against the end of main unit 21 and the elastic member 24 is compressed in between. Then adjust the cantable washer 23 inclined to cants the mobile rod 22 and hold the elastic member 24 in compressed condition. The mobile rod 22 then could not be retracted back to the inside of the main unit 21, thereby the door is arrested and kept in opened position.

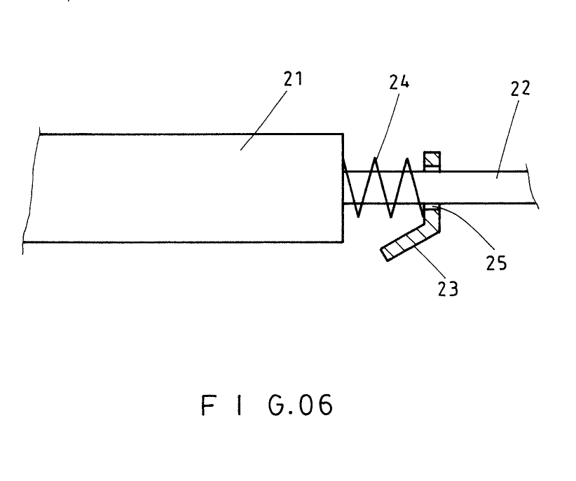

Please refer to FIG. 6; to close the door, the user pushes the door further and auto loose the cantable washer 23 from mobile rod 22 and main unit 21, the elastic member 24 be released and springs the cantable washer 23 away from the main unit 21, the mobile rod 22 retracts to the main unit 21 and the door is closed smoothly. Since the elastic member 24 is located between the main unit 21 and the cantable washer 23, this keeps the cantable washer 23 away from the contact with main unit 21 in normal operation. When the mobile rod 22 retracts back to the main unit 21, the mobile rod 22 will not be further canted by the contact with the cantable washer 23 and main unit 21. In other words, the mobile rod 22 can be retracted smoothly, and the arrested door with the present invented door closer can successfully and automatically closed by one push operation.

In the preferred embodiment shown in the drawing, when the user pushes the arrested door, the cantable washer 23 is loosed and pushed by the compressed elastic member 24 automatically and moved away from the main unit 21, even when the door is opened to its maximum, the mobile rod 22 is also be retracted successfully by the same operation. Because of the auto unlatching function of present invented door closer, even the door closer is installed at a higher position of the door, it can also be easily operated by children, physically disabled persons, senior citizens and can unlatch the arrested door simply by pushing the door further with any part of their body to have the door closed automatically. Obviously, it is more convenient and practical than the prior art of door closers.

Although the present invention has been illustrated and described with reference to the preferred embodiment thereof, it should be understood that it is not limited to the details of such embodiment but is capable of numerous modifications within the scope of the appended claims.

What is claimed is:

1. A door closer, comprising a door closer, an elastic member and a cantable washer, wherein the elastic member and cantable washer are passed and mounted on the mobile rod of door closer, and more particularly the one end of the elastic member contacts against the free end of main unit, the other end of the elastic member contacts with the surface of the cantable washer; when the mobile rod of the door closer is pushed outwardly to unlatch the cant condition between the cantable washer and the door closer's main unit, the elastic member pushes out the cantable washer, to make the mobile rod of door closer can move smoothly in relation to the cantable washer, and the mobile rod can be retracted to the main unit of door closer.
